(19) United States
(12) Patent Application Publication
(10) Pub. No.: US 2005/0253028 A1
(43) Pub. Date: Nov. 17, 2005

(54) Adjustable hand positioner for computer mouse

(76) Inventor: Robert D. Kennedy, Ottawa (CA)

Correspondence Address: NIXON PEABODY, LLP, 401 9TH STREET, NW, SUITE 900, WASHINGTON, DC, 20004-2128, US

(21) Appl. No.: 11/183,883

(22) Filed: Jul. 19, 2005

Related U.S. Application Data
(63) Continuation-in-part of application No. 10/845,090, filed on May 14, 2004.

(51) Int. Cl. B43L 15/00; B68G 5/00

(52) U.S. Cl. 248/118

(57) ABSTRACT

A mechanical device to be cooperatively associated with a computer mouse to cause proper positioning of a user's hand and wrist when using the mouse. The device comprises a support surface to be positioned both longitudinally and height-wise with respect to the mouse so as to support the heel of the user's hand so that the user's hand and wrist are in an ergonomically correct position relative to each other during use of the mouse.

### RELATED APPLICATION

The present invention is a continuation-in-part of applicant's co-pending U.S. application Ser. No. 10/845,090, filed May 14, 2004 entitled HAND POSITIONER FOR COMPUTER MOUSE, the entire contents of which are incorporated herein by reference.

### FIELD OF THE INVENTION

The present invention relates to a device which is associated with a computer mouse to cause a user's hand and wrist to be in ergonomically correct positions relative to each other during use of the mouse.

### BACKGROUND OF THE INVENTION

A computer workstation that is not ergonomically suited to a user's shape, size and capabilities may hinder the user's performance. It is important that the user's posture, including hand and arm positioning with respect to the computer mouse, where a traditional mouse is used, is such to avoid awkward alignment of the hand and arm. Otherwise, repetitive motion injuries (RMI) may arise, affecting the user's muscles, and tissues connecting bones, such as tendons and ligaments. Inadequate computer workstation design may generate a fixed awkward wrist position, thus contributing to RMI.

One of the most publicized types of RMI is carpal tunnel syndrome (CTS), in which tendons, passing through a narrow tunnel in the wrists, become inflamed and put pressure on the median nerve of the hand. This causes a tingling sensation in the thumbs and adjacent fingers, and a burning sensation in the palms.

Ideally, an ergonomically correct position for a user at a computer workstation has the wrist of the hand controlling the mouse in a neutral position, with no bending, the hand being relaxed and in straight alignment with the associated forearm. In operation, there should be no bending of the user's wrist and fingers should fall naturally downward over the controls of the mouse. The user should be able to move the mouse with a full arm movement, keeping the wrist straight and in line with his or her shoulder.

The Cornell University ergonomics website provides some tips with respect to using a computer mouse in a manner which will avoid mouse-related musculoskeletal injury, and the problems which create such injury. That website points out that there are exposed blood vessels near the skin at the wrist, where the pulse is often taken, and that any pressure in this region will disrupt circulation into the hand, increasing the risk of injury. It has also pointed out that using a wrist rest doubles the pressure inside the carpal tunnel, because the floor of the tunnel is a more flexible ligament that transmits external pressure changes directly into the carpal tunnel. Since the roof of the tunnel is bone, the pressure does not get transmitted on through the hand. A softly padded wrist rest, this website advises, especially one that is rounded causes the forearm to become “locked” into position, encouraging people to make mouse movements by flicking the wrist, and action which also increases intracarpal pressure. It is pointed out that the base of the palm of the hand in the part of the body designed to support the hand when resting on a surface.

In order to reduce and minimize RMI for computer users, a palm support is often placed in front of the keyboard to provide support for the palm of the hand during brief pauses from keying. Such a palm support provides a rounded upper surface.

A good technical description of the problems confronting users of computer mice is set out in U.S. Pat. No. 5,414,445 of Kaneko et al., issued May 9, 1995. This patent is directed to an ergonomically designed mouse which assists in keeping the user's arm, wrist and hand within a biomechanically neutral zone achieved when the flexors and extensors of the user's hand and wrists are in equilibrium, and static loads on the forearm muscles and other large muscle groups are minimized.

Hand and wrist supports for computer mice have been developed with a view to reducing RMI and preventing CTS, such as those described and illustrated in Martin et al. U.S. Pat. No. 5,340,067 issued Aug. 23, 1994 and Tajiri U.S. Pat. No. 5,581,277 issued Dec. 3, 1996 which illustrate working surface supported hand supports. A wrap around support block is described and illustrated by Martin et al., and a spherical attachment by Tajiri, in both cases to receive the palm of a user's hand and thereby support the hand and wrist in an appropriate, biomechanically neutral position. U.S. Pat. No. 6,193,196 of Hesley issued Feb. 27, 2001, describes and illustrates a working surface supported hand support in the form of an inclined planar surface which is seated beside and in front of the mouse. Again, the support surface is in the palm region of the user's hand. The bottom surface of the support permits sliding of the support device in tandem with the mouse.

Kravtin et al. U.S. Pat. No. 6,157,370 issued Dec. 5, 2000 and U.S. Pat. No. 6,396,478 issued May 28, 2002 describe and illustrate an ergonomic extension to a computer mouse, for facilitating use of the mouse by a user with the user's arm, wrist and hand in an ergonomically appropriate position. The extension is fixed to the computer mouse by way of an arm and a mechanism is provided for locking the arm in a variety of positions relative to the mouse. The extension itself provides an upper surface that conforms to a human palm, elevating the palm to a desired position with respect to the mouse during use.

Other patents of general background interest teaching hand and/or forearm supports, for mouse users include U.S. Pat. No. 5,203,845 of Moore issued Apr. 20, 1993, U.S. Pat. No. 5,944,289 of Speece issued Aug. 31, 1999, U.S. Pat. No. 5,833,180 of Baranowski issued Nov. 10, 1998 and U.S. Pat. No. 6,585,198 of Dillon issued Jul. 1, 2003.

Many of these prior art devices provide support for the user's hand through the palm (i.e. that part of the hand extending from the heel of the hand to the base of the fingers). Others provide support for the forearm and palm. These constructions often restrict the relative movement of the user's hand and wrist and often provide cumbersome solutions to the problem of RMI and CTS.

U.S. Pat. No. 6,616,108 of Brophy et al. issued Sep. 9, 2003 describes and illustrates a deformable support for cushioning a mouse user's hand and wrist. The support is releasably coupled to the mouse by arms which extend forwardly from the cushioning surface. The cushioning material may be a resilient gel or foam, or may be a non-resilient, “firm” material such as sand, metal filings, grains, beans, clay or the like. In providing a cushioned rest area for the user's hand/wrist, the hand/wrist angle may be somewhat reduced but pressure is still applied to the carpal tunnel area. When pressure is applied to this area, the nerves that run through the carpal tunnel passageway will become pressed or squeezed. As well, broad pressure in the palm region adjoining the wrist, caused by this device, will disrupt blood flow into the hand. Over long term usage, chronic discomfort may result. Also, with the increased contact area of the hand/wrist support cushion in the Brophy et al. device, wear and irritation of the skin may result in this area. Moreover, Brophy et al. does not teach adjustability of the support surface area to different sizes of users' hands, no doubt because of the large, cushioning area designed to support a large portion of the user's hand. Moreover, because of the “give” from the cushion, the wrist may tend to sag with respect to the hand, providing a misalignment between the user's hand and wrist.

In applicant's co-pending U.S. application Ser. No. 10/845,090, a device is provided to be cooperatively associated with a computer mouse, the device comprising a support surface to be positioned both longitudinally and height-wise with respect to the mouse so as to support a central area of the heel of the user's hand so that the user's hand and wrist are in an ergonomically correct position relative to each other during use of the mouse.

It is an object of the present invention to provide an economical and readily useable improvement to such prior art devices which will cause a user's hand and wrist to remain in an ergonomically correct position during use of a computer mouse.

### SUMMARY OF THE INVENTION

In accordance with the present invention there is provided a mechanical device to be attached to a computer mouse having a top, sides, a front and a back. The device, when in position on the mouse, moves with the mouse and causes proper positioning of a user's hand and wrist when the mouse moves on a surface. The device comprises a support surface secured on a body, the body having arms, when in position on the mouse, to circumscribe the front and portions of the sides of the mouse. Means associated with the arms securely engage the sides of the mouse. The support surface on the body is configured and is adjustably positionable so that when the arms are in position on the mouse, the support surface supports only a central portion of a heel of the user's hand, so that the user's hand and wrist are in an ergonomically correct, aligned position relative to each other during use of the mouse.

In a preferred embodiment of the present invention, the support surface is provided with means to releasably grip the sides of the mouse and with means for longitudinal positioning on the body, relatively towards or away from the mouse when the device is in position on the mouse, whereby proper longitudinal positioning of the support surface to support the central portion of the heel of the user's hand is provided.

In a further preferred embodiment of the present invention, means are provided for adjusting the height of the support surface with respect to the top of the mouse, when the device is in position on the mouse, so that proper positioning of the support surface to achieve alignment of a user's hand and wrist can be achieved.

The support surface device of the present invention is simple to construct and is extremely effective in supporting a user's hand, wrist (and arm) in an ergonomically correct position when using the computer mouse.

### BRIEF DESCRIPTION OF THE DRAWINGS

These and other advantages of the invention will become apparent upon reading the following detailed description and upon referring to the drawings in which:

FIG. 1 is a perspective view of one embodiment of support device as described and illustrated in applicant's co-pending application Ser. No. 10/845,090;

FIG. 2 is a perspective view of a support device to be releasably attached to a computer mouse in accordance with the present invention;

FIGS. 3 and 4 are respectively side elevation and bottom plan views of the device of FIG. 2, releasably attached to a computer mouse;

FIG. 5 is an exploded side elevation view, in partial section on embodiments of the device according to the present invention, illustrating adjustable features of the support surface; and

FIG. 6 is a perspective view of an alternative embodiment of a support device according to the present invention, illustrating adjustable features of the arms.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings have been given similar reference numerals.

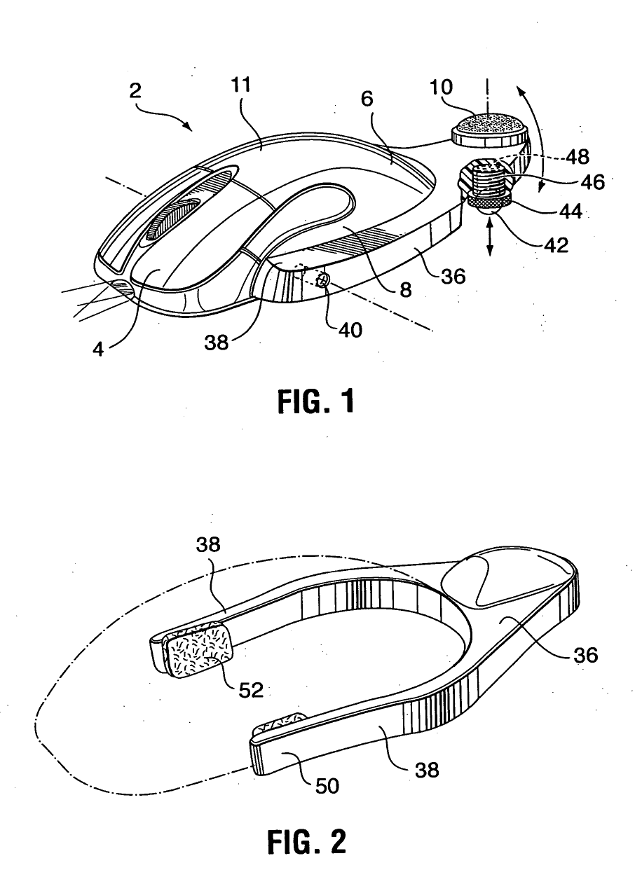

Turning to FIG. 1 there is illustrated, associated with a conventional computer mouse 2 having a rear 4, front 6 and sides 8, a support surface 10. Support surface 10 is configured and secured in appropriate position spaced longitudinally from the front 6, and located at an appropriate height relative to, the top surface 11 of mouse 2, so as to be seated in and support, during use, a central area of the heel of the user's hand. In this particular embodiment of the invention, a body 36 having arms 38 on either side to releasably grip sides 8 of mouse 2, is provided. Arms 38 are preferably pivotally attached to the appropriate position by way of securing means such as screws 40. Body 36 is moveable with mouse 2 on a working surface, a roller ball 42 being secured, as illustrated, beneath support surface 10, to facilitate that movement. The height of support surface 10 with respect to upper surface 11 of mouse 2 is adjustable by changing the positioning of knurled nut 44 on threaded post 46. A spring mechanism 48, associated with the post 46 and an underneath portion of support surface 10 provides resiliency for support surface 10. Support surface 10 is positioned at an appropriate height with respect to upper surface 11 of mouse 2, in this manner. That support surface 10 is positioned at an appropriate distance away from front 6 of mouse 2 normally to sit in the central area of the heel of the user's hand and thereby provide proper ergonomic positioning of the user's hand, wrist and forearm when using mouse 2. The pivotable adjustment feature of body 36, about the longitudinal axis of screws 40, also facilitates an appropriate ergonomic positioning height-wise of support surface 10.

In the alternative embodiment of the invention illustrated in FIGS. 2 to 5, arms 38 and body 36 have a wishbone shape when seen from above or below (e.g. FIG. 4) and releasably grip sides 8 of mouse 2, circumscribing portions of sides 8 and front 6 of mouse 2. The sides of the mouse are securely, preferably releasably, engaged by the ends 50 of arms 38 for instance as a result of spring bias urging these arms inwardly when they are in position on the sides 8 of mouse 2. Alternatively, securing means 52, such as hook and pile fasteners associated with these ends 50 and corresponding portions of the sides of mouse 2, or frictionally engaging tabs of rubber or other appropriate material, may be provided to permit secure but releasable attachment of the arms 38 and body 36 of the device to mouse 2. Alternatively, securing means 52 may be two-way tape with adhesive on either side or any other conventional attachment means.

When body 36 is thus attached to mouse 2, the support surface 10 is configured and positioned on body 36 so that, when arms 38 are in position on mouse 2, a central portion of the heel of the user's hand (FIG. 4) is supported by the support surface, ensuring that the user's hand and wrists are in an ergonomically correct, aligned position relative to each other during use of the mouse 2.

As can be seen in FIG. 5, adjustment means are provided to ensure proper longitudinal and elevational adjustment of support surface 10. These adjustment means may be of any conventional form, but, in the illustrated embodiment, comprise pegs 54 which are aligned and spaced so as to fit in appropriate ones of corresponding, longitudinally aligned holes 56 in body 36. Height adjustment of support surface 10 is accomplished, in this illustrated embodiment, by selecting a wafer 58 of appropriate thickness, having apertures 60 mating with holes 56, and securing it between support surface 10 and body 36 when pegs 54 pass through the appropriate apertures 60 in wafer 58 and holes 56 in body 36. In this manner, the appropriate longitudinal and elevational positioning of support surface on body 36, to ensure proper positioning of that support surface in the central portion of the heel of the user's hand is achieved.

For comfort, it is preferred that support surface 10 has a convexly rounded surface, for example in the shape of the back of the bowl of a spoon, elongated longitudinally in the direction of mouse 2 when the device is in position on mouse 2.

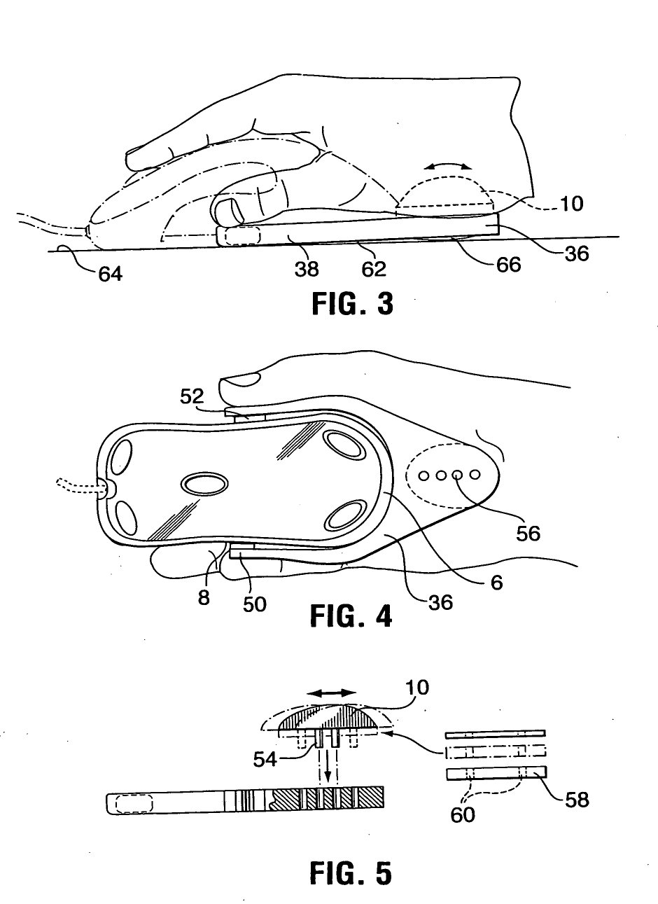

As can be seen in FIG. 3, base 62 of body 36 and arms 38, which, when the device is in position on mouse 2, rests on the same surface 64 as mouse 2. Base 62 is preferably provided with a reduced friction slider 66 or the like, to facilitate movement of the mouse and associated body 36 on surface 64.

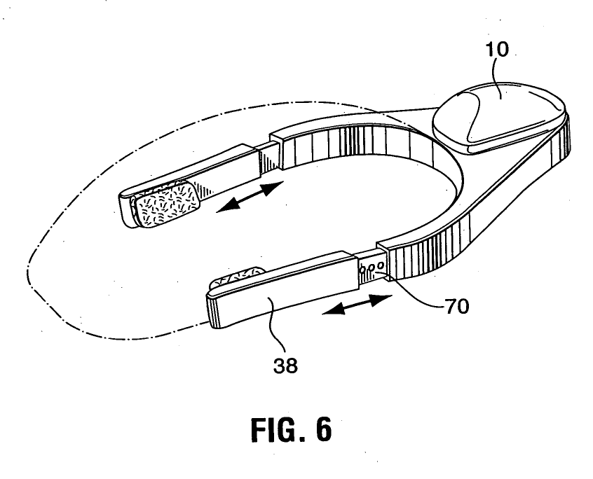

In the embodiment illustrated in FIG. 6, to facilitate the releasable attachment of body 36 to a variety of mouse sizes, arms 38 may be provided with adjustable telescopic means 70 to enable the arms to be lengthened or shortened in the longitudinal direction with respect to body 36.

The simple, wishbone shape of the device according the present invention permits its easy attachment to easy release from a mouse, making this invention easy to use and economical to construct. The adjustability of the support surface with respect to the front and top of the mouse enables the device to be readily adjustable to different sizes of hands and different shapes of mice.

Thus, it is apparent that there has been provided in accordance with the invention a hand positioner for a computer mouse that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. A device to be attached to a computer mouse having a top, sides, a front and a back, the device, when in position on the mouse, to move with the mouse and cause proper positioning of a user's hand and wrist when the mouse moves on a surface, the device comprising a support surface secured on a body, the body having arms, when in position on the mouse to circumscribe the front and portions of the sides of the mouse, and means associated with the arms securely to engage the sides of the mouse, the support surface on the body being configured and adjustably positionable so that, when the arms are in position on the mouse, the support surface supports only a central portion of a heel of the user's hand so that the user's hand and wrist are in an ergonomically correct, aligned position relative to each other during use of the mouse.

2. A device according to claim 1, wherein the means associated with the arms securely to engage the sides of the mouse are constructed so as to releasably grip the sides of the mouse.

3. A device according to claim 2, wherein the arms are spring-loaded so as to be biased inwardly to releasably secure the arms to the sides of the mouse, when in position on the sides of the mouse.

4. A device according to claim 2, wherein the engagement means comprise hook and pile fasteners associated with the arms and the sides of the mouse.

5. A device according to claim 1, wherein the support surface is provided with means for longitudinal positioning on the body, relatively towards or away from the mouse when the device is in position on the mouse, whereby proper longitudinal positioning of the support surface to support the central portion of the heel of the user's hand is provided.

6. A device according to claim 2, wherein the support surface is provided with means for its longitudinal positioning on the body, relatively towards or away from the mouse when the device is in position on the mouse, whereby proper longitudinal positioning of the support surface to support the central portion of the heel of the user's hand on the surface is provided.

7. A device according to claim 5, wherein means are provided for adjusting the height of the support surface, when the device is in position on the mouse relative to the height of the mouse so that the user's hand and wrist are in an ergonomically correct aligned position relative to each other during use of the mouse.

8. A device according to claim 6, wherein means are provided for adjusting the height of the support surface, when the device is in position on the mouse relative to the height of the mouse so that the user's hand and wrist are in an ergonomically correct aligned position relative to each other during use of the mouse.

9. A device according to claim 1, wherein means are provided for adjusting the height of the support surface, when the device is in position on the mouse relative to the height of the mouse so that the user's hand and wrist are in an ergonomically correct aligned position relative to each other during use of the mouse.

10. A device according to claim 2, wherein means are provided for adjusting the height of the support surface, when the device is in position on the mouse relative to the height of the mouse so that the user's hand and wrist are in an ergonomically correct aligned position relative to each other during use of the mouse.

11. A device according to claim 7, wherein the means for longitudinal positioning of the support surface comprise a series of longitudinally aligned, co-operating apertures and pegs in the support surface and body.

12. A device according to claim 8, wherein the means for longitudinal positioning of the support surface comprise a series of longitudinally aligned, co-operating apertures and pegs in the support surface and body.

13. A device according to claim 11, wherein the height adjustment means comprises a wafer of appropriate thickness to be secured between the support surface and the body.

14. A device according to claim 12, wherein the height adjustment means comprises a wafer of appropriate thickness to be secured between the support surface and the body.

15. A device according to claim 1, wherein the support surface is a rounded convex surface elongated in the direction towards and away from the mouse when in position on said mouse.
